(19) United States
(12) Patent Application Publication
(10) Pub. No.: US 2025/0225222 A1
(43) Pub. Date: Jul. 10, 2025

(54) TARGET MANAGEMENT SYSTEM

(71) Applicant: TOYOTA JIDOSHA KABUSHIKI KAISHA, Aichi-ken (JP)

(72) Inventors: Takahiro IWASAKI, Kiyose-shi (JP); Yuta MORI, Urayasu-shi (JP); Koki SONE, Taito-ku (JP); Bing XUE, Edogawa-ku (JP)

(21) Appl. No.: 19/011,612

(22) Filed: Jan. 7, 2025

(30) Foreign Application Priority Data
Jan. 10, 2024 (JP) 2024-002032

(51) Int. Cl. G06F 21/32; G06V 40/16

(52) U.S. Cl. CPC G06F 21/32; G06V 40/168; G06V 40/172

(57) ABSTRACT

A target management system includes one or more memory devices configured to store a registered image of each of one or more targets and processing circuitry. The processing circuitry is configured to execute a determination process to determine whether a subject in a subject image is identical to any of the targets, provide a determination request to a user terminal when a specific condition is satisfied, and strengthen association between the subject and a specific target when a determination response indicates that the subject and the specific target are identical.

### CROSS-REFERENCE TO RELATED APPLICATION

This application claims priority to Japanese Patent Application No. 2024-002032 filed on Jan. 10, 2024, the entire contents of which are incorporated by reference herein.

### TECHNICAL FIELD

The present disclosure relates to a technique for managing a target.

### BACKGROUND ART

Patent Literature 1 discloses a monitoring device to monitor a process performed by a biometric verification device. The monitoring device displays a result of the process such as a face image of a passer-by who is not authenticated as a registrant in a verification process by the face image. A monitoring person can immediately determine whether the passer-by is a registrant or not by checking the result of the process.

### LIST OF RELATED ART

Patent Literature 1: Japanese Laid-Open Patent Application No. 2009-093371

### SUMMARY

A technique is known which determines whether a subject is identical to a specific target based on an image captured by a camera. There may be a case where it is unclear whether the subject is identical to a specific target or not.

A purpose of the present disclosure is to provide a technique to improve accuracy of determination even in a case where it is unclear whether the subject is identical to a specific target or not.

A first aspect relates to a target management system.

The target management system includes:
one or more memory devices configured to store a registered image of each of one or more targets and processing circuitry.

The processing circuitry is configured to:
acquire a subject image that is an image of a subject captured by a camera;
execute a determination process to determine whether the subject is identical to any of the one or more targets based on the registered image and the subject image;
provide a determination request for requesting a determination of who the subject is to a user terminal together with the subject image when a result of the determination process satisfies a specific condition; and
when a determination response indicating that the subject and a specific target of the one or more targets are identical is received from the user terminal in response to the determination request, strengthen association between the subject and the specific target in the determination process.

According to the present disclosure, even when it is not possible to determine whether the subject and the target are identical by the determination process, correct determination can be done by requesting the determination to the user, who can reliably distinguish the subject and the target, through the determination request. In addition, since the association between the subject image and the specific target is strengthened by accumulating the determination response, the accuracy of the determination process is gradually improved. Accordingly, the frequency of providing the determination request gradually decreases.

### BRIEF DESCRIPTION OF DRAWINGS

FIG. 1 is a schematic diagram showing an overview of a target management system;

FIG. 2 is a schematic diagram for explaining an example of a determination process;

FIG. 3 is a block diagram showing an example of a configuration of a management device;

FIG. 4 is a flowchart showing an example of a processing flow of the target management system;

FIG. 5 is a flowchart corresponding to a second example of a variation of the target management system 1.

FIG. 6 is a schematic diagram showing an example of a display screen of a user terminal when a subject image is provided together with a determination request.

### DETAILED DESCRIPTION

Embodiments of the present disclosure will be described with reference to the drawings.

### 1. Target Management System

### 1-1. Overview of Target Management System

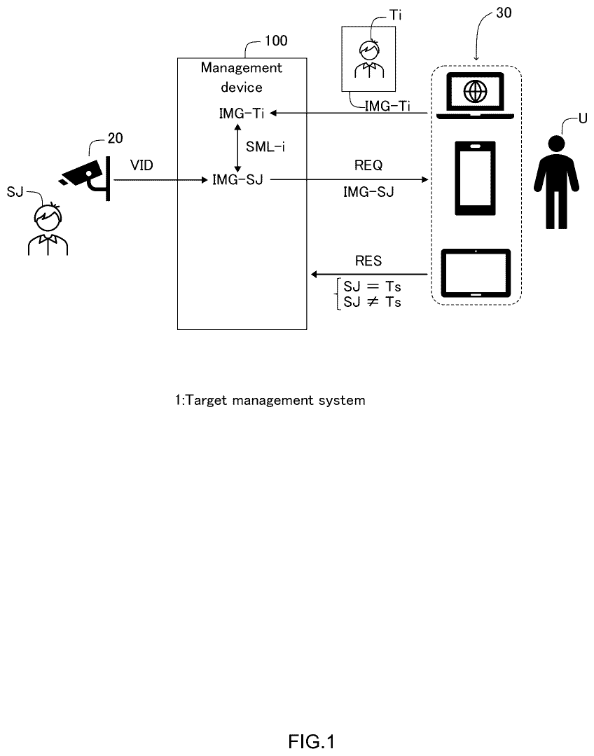

FIG. 1 is a schematic diagram showing an overview of a target management system 1. The target management system 1 includes a camera 20, a user terminal 30, and a management device 100.

Camera 20 captures the entire area where it is installed. The camera 20 is preferably installed where one or more targets Ti (hereinafter simply referred to as a target Ti) to be managed appear periodically or frequently. The user terminal 30 is an information terminal that can be operated by a user U. The user terminal 30 includes a user interface that presents information to the user U and receives an input by the user U. The user terminal 30 and the management device 100 can communicate with each other via a wireless or wired communication network. Specific examples of the user terminal 30 include a smartphone, a tablet, and a PC, etc. Examples of the user interface include a touch screen, a PC display, etc. The management device 100 manages the target management system 1. Typically, the management device 100 is a management server on a cloud. The management device 100 may be configured by a plurality of servers that perform distributed processing.

Camera 20 is just an example of a camera used in the target management system 1. A plurality of cameras may be installed throughout the entire living area of the target Ti (for example, the entire city) in practice. In this case, each camera communicates with the management device 100 via a communication network, and the captured image data is intensively managed by the management device 100.

How the target management system 1 works will be briefly described. The management device 100 acquires the video VID from the camera 20 and extracts an image of the subject SJ (subject image IMG-SJ) shown in the video VID. The management device 100 executes a determination process to determine whether the subject SJ is identical to any of the target Ti. In the determination process, the subject image IMG-SJ is compared with an image of the target Ti registered in the management device 100 in advance. Such an image is hereinafter referred to as a registered image IMG-Ti. When a result of the determination process satisfies a specific condition, the management device 100 provides the user terminal 30 with the subject image IMG-SJ and a determination request REQ. The determination request REQ requests the user U to determine who the subject SJ is. The user U transmits a determination response RES, which is a response to the determination request REQ, via the user terminal 30. When the determination response RES indicates that the subject SJ and a specific target Ts of the target Ti are identical, the management device 100 strengthens association between the subject SJ and the specific target Ts in the determination process.

A case where the target management system 1 is used is that parents watch their child attending a school. In this case, the target Ti corresponds a child attending a school, and the user U corresponds the parent of the target Ti. The camera 20 is preferably installed at a school gate etc. The registered image IMG-Ti is registered in the management device 100 by the user U via the user terminal 30. The user U does not need to be a parent of the target Ti, but it is preferable that the user U can certainly determine whether the subject image IMG-SJ is identical to any one of the subject SJ and the target Ti by checking the subject image IMG-SJ.

### 1-2. Determination Process

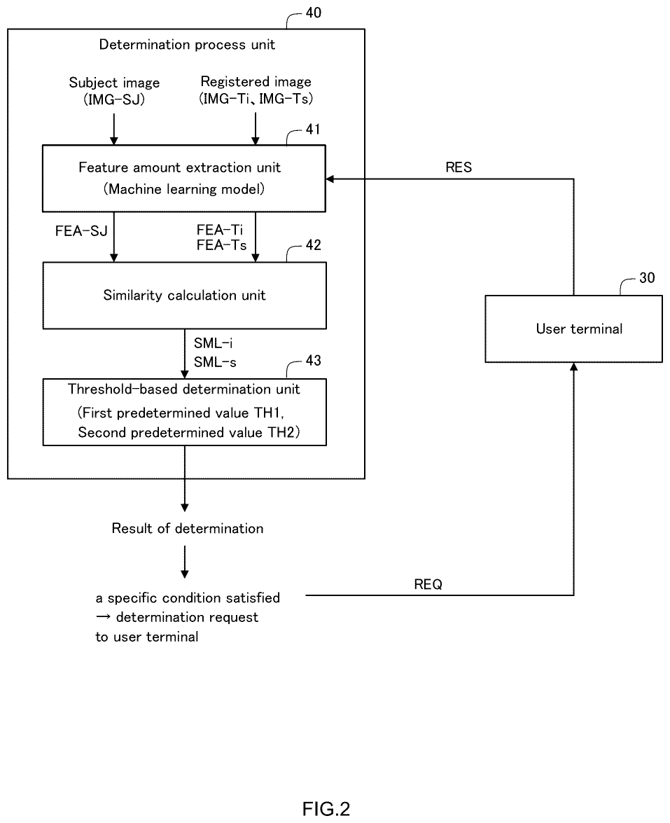

FIG. 2 is a schematic diagram for explaining an example of the determination process. The determination process is performed by a determination process unit 40. The determination process includes steps such as feature amount extraction, similarity calculation, and threshold-based determination.

A feature amount extraction unit 41 extracts a subject feature amount FEA-SJ from the subject image IMG-SJ using a machine learning model. Similarly, the feature amount extraction unit 41 extracts a target feature amount FEA-Ti from the registered image IMG-Ti. The machine learning model is generated in advance through machine learning such as deep learning. Specifically, the subject feature amount FEA-SJ and the target feature amount FEA-Ti are feature vectors representing a feature included in each image.

A similarity calculation unit 42 calculates image similarity SML-i by comparing the subject feature amount FEA-SJ and the target feature amount FEA-Ti. Specifically, the closer the subject feature quantity FEA-SJ and the target feature quantity FEA-Ti are, the higher the image similarity SML-i is calculated. Conversely, the image similarity SML-i is calculated to be lower as the subject feature quantity FEA-SJ and the target feature quantity FEA-Ti are farther from each other.

A threshold-based determination unit 43 compares the image similarity SML-i with a predetermined threshold. For example, when the image similarity SML-i is lower than a first predetermined value TH1, the threshold-based determination unit 43 determines that the subject SJ is not identical to the target Ti. On the other hand, when the image similarity SML-i is higher than a second predetermined value TH2, the threshold-based determination unit 43 determines that the subject SJ is identical to the target Ti. Normally, the second predetermined value TH2 is set to be higher than the first predetermined value TH1.

There may be a case where it is unclear whether the subject SJ is identical to the target Ti (that is, a case where the reliability of the determination process is not high). For example, if the target Ti is a twin, it tends to be unclear which of the twins of the target Ti the subject SJ is. Such a case is defined as a “specific condition”. An example of the specific condition is that the image similarity SML-i is within a certain range (for example, equal to or higher than the first predetermined value TH1 and equal to or lower than the second predetermined value TH2).

A case where a result of the determination process satisfies the specific condition means that whether the subject SJ is identical to the target Ti is unclear. Therefore, when the result of the determination process satisfies the specific condition, the management device 100 provides the determination request REQ to the user terminal 30. The determination request REQ requests the user U to determine who the subject SJ is. In other words, the management device 100 provides the determination request REQ when it cannot determine whether the subject SJ is identical to the target Ti with high reliability, based on the result of the determination process performed by the management device 100 itself.

When the determination response RES indicates that the subject SJ and the specific target Ts are identical, the feature amount extraction unit 41 updates the machine learning model. Specifically, the feature amount extraction unit 41 updates the machine learning model so that “the subject feature amount FEA-SJ extracted from the subject image IMG-SJ” and “the specific target feature amount FEA-Ts extracted from the registered image of the specific target Ts (referred to as a specific registered image IMG-Ts)” get closer to each other. In other words, the feature amount extraction unit 41 updates the machine learning model so that specific image similarity SML-s between the current subject SJ and the specific target Ts further increases. That is, the association between the current subject SJ and the specific target Ts in the determination process is strengthened.

Face images are mainly used for the subject feature amount FEA-SJ and the target feature amount FEA-Ti used for the feature amount extraction. Face images are effective in the determination process because face images include feature amounts peculiar to individuals (peculiar feature amounts). On the other hand, the feature amount extraction unit 41 may include a machine learning model for extracting a temporary feature amount (e.g., clothes or hairstyle) separately from the extraction of the peculiar feature amount. The temporary feature amount is used in the determination process only for a certain period. For example, the feature amount extraction unit 41 holds the temporary feature amount of the target Ti extracted for the first time on a certain day in the management device 100. The similarity calculation unit 42 compares the “temporary feature amount extracted for the second or subsequent time of the day” with the “held temporary feature amount” to calculate “temporary similarity”. The similarity calculation unit 42 calculates “integrated similarity” by combining “similarity based on the peculiar features” and “temporary similarity”. In this case, the threshold-based determination unit 43 uses the integrated similarity for threshold-based determination. The feature amount extraction unit 41 resets the “temporary feature amount” when the day ends. The period during which the temporary feature amount is held and used for the determination process is not limited to one day. The period can be set as, for example, one week or one month.

### 2. Configuration and Processing Flow of Management Device

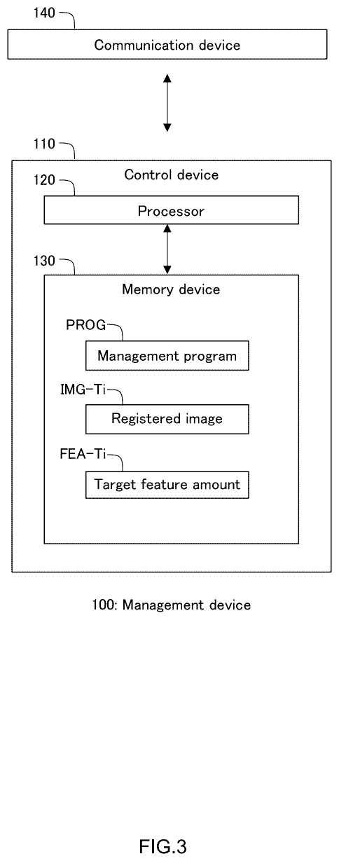

FIG. 3 is a block diagram showing an example of a configuration of the management device 100.

The management device 100 includes a control device 110 and a communication device 140. The communication device 140 communicates with the user terminal 30 and the camera 20. The control device 110 controls the management device 100. The control device 110 includes one or more processors 120 (hereinafter, simply referred to as a processor 120) and one or more memory devices 130 (hereinafter, simply referred to as a memory device 130). The processor 120 executes various processes. For example, the processor 120 includes a central processing unit (CPU). The processor 120 may also be referred to as processing circuitry. The memory device 130 stores various kinds of information necessary for processes by the processor 120. Examples of the memory device 130 include a volatile memory, a nonvolatile memory, a hard disk drive (HDD), and a solid-state drive (SSD).

A management program PROG is a computer program executed by the processor 120. The processor 120 may execute the management program PROG to implement the functions of the control device 110. The management program PROG is stored in the memory device 130. Alternatively, the management program PROG may be recorded in a computer-readable recording medium. The management program PROG may be provided via a network.

The control device 110 transmits and receives data to and from the camera 20 and the user terminal 30 via the communication device 140. The control device 110 also functions as a determination process unit 40 that executes the determination process.

The memory device 130 stores the registered image IMG-Ti and the target feature amount FEA-Ti. When the temporary feature amount is used in the determination process, the temporary feature amount is stored in the memory device 130.

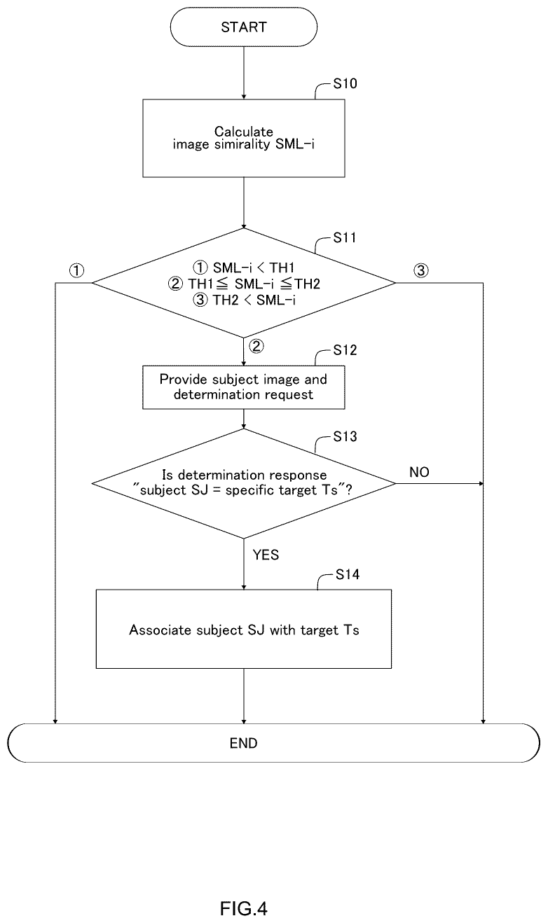

FIG. 4 is a flowchart showing an example of a processing flow of the target management system 1.

In a step S10, processor 120 acquires the subject image IMG-SJ and calculates the image similarity SML-i between the subject image IMG-SJ and the registered image IMG-Ti.

In a step S11, processor 120 compares the image similarity SML-i with thresholds. For example, when the image similarity SML-i is lower than the first predetermined value TH1, processor 120 determines that the subject SJ is not identical to the target Ti. On the other hand, when the image similarity SML-i is higher than the second predetermined value TH2, processor 120 determines that the subject SJ is identical to the target Ti. The steps S10 and S11 correspond to the determination process. However, when the image similarity SML-i is equal to or higher than the first predetermined value TH1 and equal to or lower than the second predetermined value TH2, it is unclear whether the subject SJ is identical to the target Ti, that is, the specific condition is satisfied. In this case, the process proceeds to a step S12.

In the step S12, processor 120 provides the user terminal 30 with the subject image IMG-SJ and the determination request REQ. The process proceeds to a step S13.

In the step S13, processor 120 determines the next process according to what the determination response RES to the determination request REQ transmitted from the user terminal 30 indicates. If the determination response RES indicates “the subject SJ and the specific target Ts are identical” (the step S13: YES), the process proceeds to a step S14. On the other hand, when the determination response RES indicates that “the subject SJ and the specific target Ts are not identical” (the step S13: NO), the process ends.

In the step S14, processor 120 strengthens the association between the subject SJ and the specific target Ts. Then, the process ends.

### 3. Effect

Even when the management device 100 cannot determine whether the subject SJ and the target Ti are identical or not, the target management system 1 can make a correct determination by requesting the user U, who can reliably distinguish the subject SJ and the target Ti to make a determination via the determination request REQ. Further, since the association between the subject image IMG-SJ and the specific target Ts is strengthened as the determination response RES is accumulated, the accuracy of the determination process executed by the management device 100 itself is gradually improved. Accordingly, the frequency of providing the determination request REQ is gradually reduced. In other words, the target management system 1 can efficiently learn the characteristics of the target Ti via the determination request REQ and the determination response RES, leading to gradual increase in the accuracy of the determination process.

The above-described temporary feature amount (clothes, hair style, etc.) is particularly effective immediately after the target management system 1 starts to be used. That is, even in a stage where feature learning for the target Ti is not enough, the determination accuracy can be temporarily increased by using the temporary feature amount.

### 4. Variations

### 4-1. First Variation

Another example of the specific condition for providing the determination request REQ is that, in the determination process, the image similarity SML-i equal to or higher than a predetermined value is calculated for the target Ti, and then the image similarity SML-i equal to or higher than a predetermined value is calculated again for the same target Ti within a predetermined period. Depending on the installed location of the camera 20, it is unlikely that the same person appears at the same location a plurality of times within a predetermined time. For example, it is assumed that the camera 20 is installed at a school gate, and an image similarity SML-i (equal to or higher than a predetermined value) with the target Ti is calculated for a certain subject during time when students coming to the school. Thereafter, it is assumed that the image similarity SML-i (equal to or higher than a predetermined value) with the same target Ti is calculated for a certain subject again during the same period of time. Since a student does not usually go to school twice in a short period of time, it is probable in this case that either of the determination processes performed twice by the management device 100 is wrong. In such a case, the management device 100 can get feedback about the result of the determination process performed by the management device 100 itself by transmitting the determination request REQ and using the determination response RES of the user U.

### 4-2. Second Variation

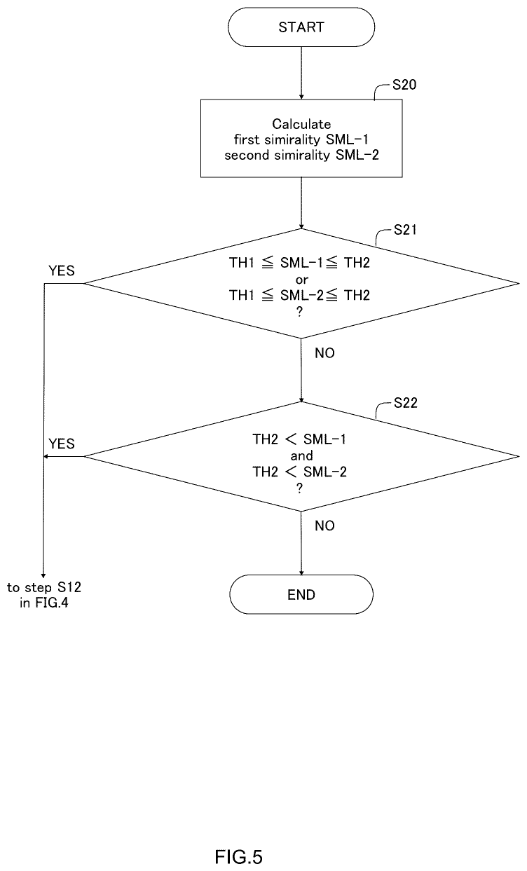

In this section, a case where the targets Ti are plural will be described. Here, the targets Ti is described as a first target T1 and a second target T2. The registered images of the first target T1 and the second target T2 are referred to as a first registered image IMG-T1 and a second registered image IMG-T2, respectively. FIG. 5 is a flowchart corresponding to the second variation.

In a step S20, processor 120 calculates a first image similarity SML-1 between the subject image IMG-SJ and the first registered image IMG-T1. Similarly, the processor 120 also calculates a second image similarity SML-2 between the subject image IMG-SJ and the second registered image IMG-T2.

In a step S21, processor 120 compares the first image similarity SML-1 with the first predetermined value TH1 and the second predetermined value TH2. Similarly, the processor 120 compares the second image similarity SML-2 with the first predetermined value TH1 and the second predetermined value TH2. When at least one of the first image similarity SML-1 and the second image similarity SML-2 is equal to or higher than the first predetermined value TH1 and equal to or lower than the second predetermined value TH2 (the step S21; YES), the process proceeds to the step S12 in FIG. 4. Otherwise (the step S21: NO), the process proceeds to a step S22.

In the step S22, the processor 120 compares the first image similarity SML-1 and the second image similarity SML-2 with the second predetermined value TH2. When both the first image similarity SML-1 and the second image similarity SML-2 are higher than the second predetermined value TH2 (the step S22: YES), the process proceeds to the step S12 in FIG. 4. Otherwise (the step S22: NO), the process ends.

The situation in which the result is “YES” in the step S21 is a situation in which “the image similarity SML-i of any one of the targets Ti is within a certain range, and it is unclear whether the subject SJ and the target Ti are identical”. On the other hand, the situation in which the result is “YES” in step S22 is a situation in which “both of the image similarity SML-i of the target Ti are high, and both of the targets Ti can be determined to be identical to the subject SJ”. Providing the user terminal 30 with the subject image IMG-SJ and the determination request REQ in the step S12 is reasonable in such situations.

As described above, the target management system 1 is applicable even when there is the plurality of targets Ti. In particular, when the appearances of the targets Ti are considerably similar to each other (for example, when the targets Ti are multiplets such as twins or siblings with similar appearances), the management device 100 may not make a correct determination alone. On the other hand, the user U (typically the parent of the targets Ti) can reliably distinguish between targets Ti, even though they are considerably similar to each other. Therefore, the feature of the target management system 1 that the user U's assistance is used via the determination request REQ can be particularly suitable for this situation.

### 5. Examples of Display Showing Determination Request

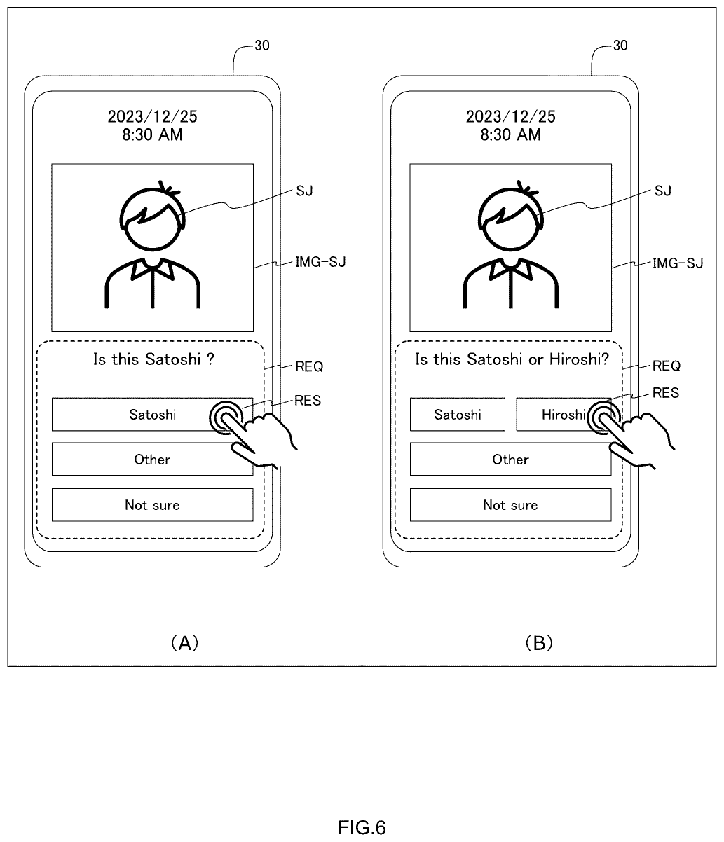

FIG. 6 is a schematic diagram illustrating an example of a display screen of the user terminal 30 when the subject image IMG-SJ is provided together with the determination request REQ.

Part A in FIG. 6 is an example of a display screen in a case where only the first target T1, named “Satoshi”, is registered. In the determination request REQ, three options are displayed: “Satoshi”, “Other”, and “Not sure”. When “Satoshi” is selected as the determination response RES, the feature amount extraction unit 41 strengthens association between the subject SJ and “Satoshi” (the first target T1). That is, “Satoshi” (first target T1) is regarded as the specific target Ts. When “Other” or “Not sure” is selected as the determination response RES, the feature amount extraction unit 41 does not update the machine learning model. When “Other” is selected, the feature amount extraction unit 41 may learn the subject feature amount FEA-SJ included in the subject image IMG-SJ as a parameter characterizing another person (a person different from the first target T1) with another machine learning model.

Part B in FIG. 6 shows an example of a display screen in a case where the second target T2, named “Hiroshi”, is registered in addition to the first target T1: “Satoshi”. In the determination request REQ, four options are displayed: “Satoshi”, “Hiroshi”, “Other”, and “Not sure”. When “Satoshi” or “Hiroshi” is selected as the determination response RES, the feature amount extraction unit 41 strengthens association between the subject SJ and the selected one (the specific target Ts). When “Other” or “Not sure” is selected, the same process is executed shown in the example of part A in FIG. 6.

Other possible embodiments will be described below (drawing omitted).

The management device 100 may request the user U to provide an image satisfying a predetermined condition via the user terminal 30. For example, when the accuracy of the determination process is particularly low for an image captured from a specific angle, the management device 100 requests the user U to transmit an image of the target Ti captured from the specific angle. In this case, a message requesting the user U to provide an image of the target Ti captured from the specific angle is displayed on the user terminal 30 together with the determination request REQ. The image provided through the image request improves low accuracy of the determination process. Therefore, the feature amount extraction unit 41 can efficiently increase the accuracy of the determination by learning the feature amount included in the image. Conversely, the user U may request the management device 100 to provide an image satisfying a predetermined condition. For example, when the user U cannot make the determination response RES based on the image at the angle captured by the camera 20, the user U may request the management device 100 to provide an image captured at another angle by a camera other than the camera 20. In this case, a field to be input the user U's request is provided on the display screen together with the determination request REQ.

Further, when the user U determines that the subject SJ and the specific target Ts are identical, the user U may indicate a specific part of the subject image IMG-SJ along with the determination response RES. For example, the user U may specify a face part on which focuses to determine by tapping or clicking the part. The feature amount extraction unit 41 uses the feature related to the specified part for the association between the subject SJ and the specific target Ts. In this case, since information of a feature to be noted is also accumulated together with the determination response RES to the determination request REQ, the association between the subject SJ and the specific target Ts more efficiently progress.

What is claimed is:

1. A target management system comprising:
one or more memory devices configured to store a registered image of each of one or more targets; and
processing circuitry, wherein
the processing circuitry is configured to:
acquire a subject image that is an image of a subject captured by a camera;
execute a determination process to determine whether the subject is identical to any of the one or more targets based on the registered image and the subject image;
provide a determination request for requesting a determination of who the subject is to a user terminal together with the subject image when a result of the determination process satisfies a specific condition; and
when a determination response indicating that the subject and a specific target of the one or more targets are identical is received from the user terminal in response to the determination request, strengthen association between the subject and the specific target in the determination process.

2. The target management system according to claim 1, wherein
the one or more targets include a first target,
in the determination process, the processing circuitry calculates a first image similarity between the registered image of the first target and the subject image, and
the specific condition is that the first image similarity is equal to or higher than a first predetermined value and equal to or lower than a second predetermined value.

3. The target management system according to claim 1, wherein
when the determination response indicating that the subject and the specific target are identical is received from the user terminal, the processing circuitry is configured to:
temporarily use a temporary feature amount of the subject included in the subject image in the determination process, the temporary feature amount characterizing the specific target; and
use a peculiar feature amount of the subject included in the subject image in the determination process for a longer period than the temporary feature amount, the peculiar feature amount characterizing the specific target.

4. The target management system according to claim 1, wherein
the one or more targets include a first target and a second target,
in the determination process, the processing circuitry calculates a first image similarity between the registered image of the first target and the subject image and a second image similarity between the registered image of the second target and the subject image, and
the specific condition includes at least one of:
a first condition that at least one of the first image similarity and the second image similarity is equal to or higher than a first predetermined value and equal to or lower than a second predetermined value; and
a second condition that both the first image similarity and the second image similarity are higher than the second predetermined value.

5. The target management system according to claim 4, wherein
the first target and the second target are multiplets or siblings.
